(19) United States
(12) Patent Application Publication
(10) Pub. No.: US 2012/0012735 A1
(43) Pub. Date: Jan. 19, 2012

(54) SIDEWALL UNIT FOR CASTING MOLD AND REMOVAL UNIT FOR SIDEWALL UNIT

(75) Inventors: Pekka KORKIAMÄKI, Toijala (FI); Lassi JÄRVINEN, Valkeakoski (FI)

(73) Assignee: ELEMATIC GROUP OY, Toijala (FI)

(21) Appl. No.: 13/158,834

(22) Filed: Jun. 13, 2011

(30) Foreign Application Priority Data
Jun. 15, 2010 (FI) 20105685

(51) Int. Cl. B29C 37/00

(52) U.S. Cl. 249/187.1

(57) ABSTRACT

A casting mold sidewall unit including a sidewall part restricting the outer surface of the concrete product to be cast, as well as a sidewall part support structure, said sidewall unit including at least one removal device extending through the sidewall part, said removal device being at least partly movable outwardly from the sidewall part surface level in order to remove the sidewall unit from the hardened concrete product. Also, a removal unit to be connected to the sidewall unit.

The invention relates to casting concrete products and elements by mold casting. More specifically, the invention relates to a sidewall unit to be used when making the casting mold, and to removing said sidewall unit from the cast concrete product while dismounting the mold after casting.

When manufacturing prefabricated concrete products by mold casting, the manufacturing process is started by first building on the casting bed a mold that defines the measures of the product to be cast. Generally this is nowadays carried out by building the mold on a metallic tiltable casting table of mold sidewall elements that are attached by means of magnets. When the mold defining the external measures of the mold is finished, inside the mold there are, when necessary, respectively formed areas bordered by sidewall elements, for example for windows, doors or other corresponding allocations defining the casting area of the cast product. Moreover, when necessary, various devices are placed on the casting table inside the mold for forming the required allocations, such as cardboard, provided with surface retarder, that is set on the casting table while casting graphic concrete. At the final stage of preparing the mold, it is provided with the necessary reinforcements, whereafter concrete mass is cast in the mold.

Mold casting of prefabricated concrete products can be realized on a stationary casting table, or in a circulating mold line. In a circulating mold line, the different steps of the casting process, such as building the casting mold and casting concrete mass in the mold, are realized in separate work stations, and the casting mold with its bed are conveyed from one work station to another along a conveyor line.

When a concrete product is hardened, it is removed from the mold, generally by removing part of the casting mold sidewalls, by tilting the casting bed and by lifting the cast concrete product from the casting bed at lifting lugs provided in the cast product.

At present, the sidewall units or elements used for building a casting mold are often composed of a sidewall part defining the surface of the concrete product to be cast, and of a support structure supporting the sidewall part. The sidewall part is often a plate-like part, where protrusions can be formed on the surface defining the concrete product in order to shape the edges of the concrete product. Generally the material of the sidewall part is plywood, plastic or steel. The support structure of the sidewall part is often made of lightweight aluminum profile in order to provide for an easy handling of the sidewall unit. Usually the sidewall unit is attached in place on the casting bed by means of fastening magnets, which can be part of the sidewall unit, or a separate individual magnet units.

In the building and dismounting of a casting mold, there is often used a so-called sidewall robot that places the sidewall units on the correct locations on the casting bed in order to build the mold, and fastens the sidewall units to the casting bed by means of fastening magnets. When dismounting the casting mold, the sidewall robot respectively detaches the fastening magnets from the casting bed and removes the sidewall units from the casting bed prior to removing the cast concrete product from the casting bed.

However, in the dismounting of a casting mold, the problem is how to remove the sidewall units from the cast concrete product after the concrete product is hardened, because the sidewall units may stick fast to the hardened concrete mass. This is a problem particularly when using a sidewall robot, because in that case the removal of hard-stuck sidewall units must be carried out manually, which slows down the manufacturing process. Such situations prevent a complete automatization of the casting process, which means that the advantage gained by using a sidewall robot is at least partly lost.

In the present invention, the sidewall unit is provided with a separate removal unit, said removal unit comprising a removal device that is moved from that surface of the sidewall unit that faces the cast product towards the cast product, and by this movement of the removal device, the sidewall unit is forced to be detached from the cast product.

By means of an arrangement according to the invention, the sidewall unit can be removed from a cast concrete product quickly and easily, which means that the manufacturing process of the concrete product can be speeded up. Moreover, the arrangement according to the invention is extremely advantageously suitable to be used with sidewall robots.

More precisely, the sidewall unit according to the invention is characterized by what is set forth in the characterizing part of claim 1, and the removal unit according to the invention is characterized by what is set forth in the characterizing part of claim 6.

The invention is described in more detail below, by way of example, with reference to the appended drawings, where

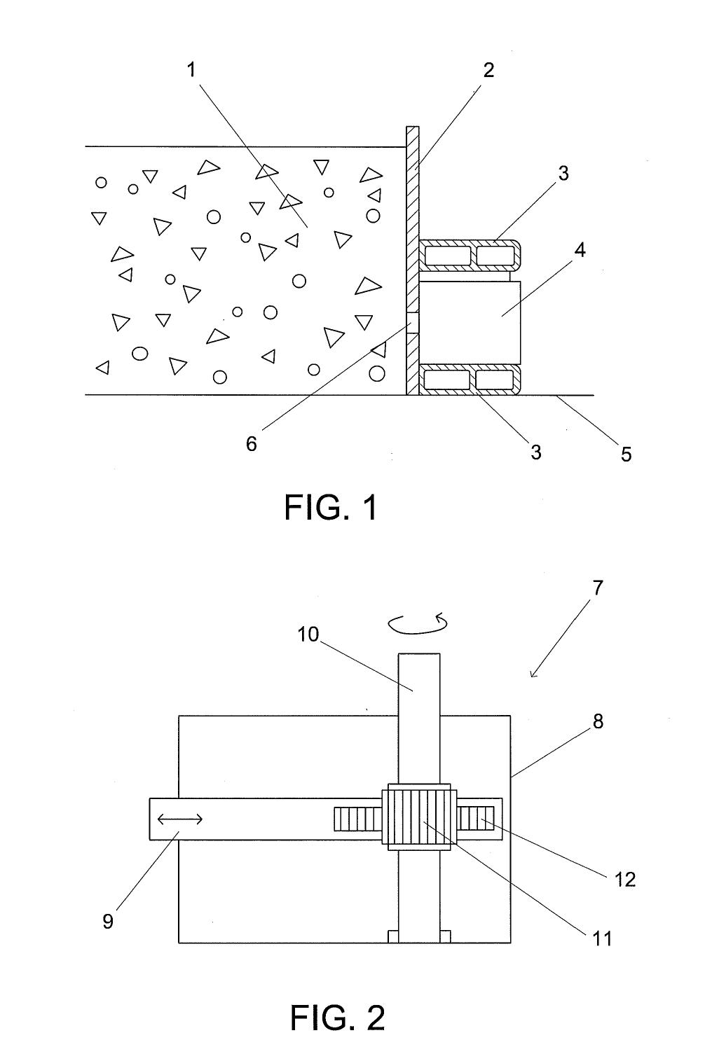

FIG. 1 is a schematical illustration of a sidewall unit according to the invention,

FIG. 2 is a schematical illustration of a sidewall unit removal unit according to the invention, and

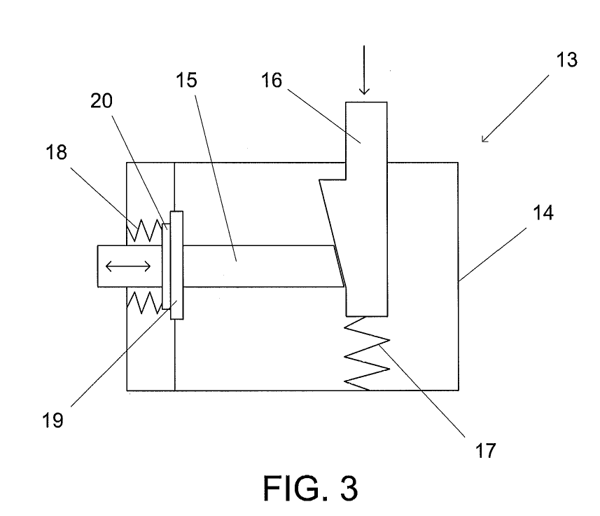

FIG. 3 is a schematical illustration of an alternative sidewall unit removal unit according to the invention.

FIG. 1 illustrates a sidewall unit according to the invention as installed in place and in partial cross-section. The sidewall unit illustrated in FIG. 1 comprises a sidewall part 2 restricting the outer surface of the cast concrete product 1, a support structure 3 of the sidewall part, and a removal unit 4.

The sidewall unit is advantageously fastened to the casting bed 5 by one or more separate fastening magnets or fastening magnet units (not illustrated) through the is support structure 3 of the sidewall unit. The fastening of the magnet unit to the support structure 3 can be realized for example by a protrusion extending from the front surface of the magnet unit, or the fastening can be realized by placing the magnet unit at least partly within the interior of the support structure of the sidewall unit.

The support structure 3 of the sidewall unit is advantageously made of aluminun profile, which as a lightweight material creates a light and easily handled structure for the sidewall unit, and is also economically advantageous as the material for the support structure.

The removal unit 4, attached to the sidewall unit support structure 3 and/or to the sidewall part 2, comprises a movable removal device 6. The removal device 6 is arranged to extend, along the hole made in the sidewall part 2, from the outer surface of the removal unit 4 to that surface of the sidewall part 2 that restricts the concrete product 1. In shape and size, the diameter of the removal device 6 substantially corresponds to the aperture made in the sidewall part 2, in which case the concrete mass cannot penetrate into the space left in between the side edges of the removal device and the edges of the aperture of the sidewall part. Moreover, the end surface of the removal device 6 is essentially even and is, in a concrete mass casting situation, placed substantially on the level of that surface of the sidewall part 2 that restricts the concrete product 1, in which case the use of the removal device 6 and the removal unit 4 as part of the sidewall unit does not substantially weaken the surface quality of the cast product.

After the cast concrete product 1 is hardened and the surrounding mold is being dismounted, the sidewall unit is first detached from the casting bed by removing the separate fastening magnet units that fasten the sidewall unit to the casting bed, or alternatively by detaching the fastening magnets that form part of the sidewall unit from the casting bed. Thereafter the removal device 6 of the removal unit 4 is moved from that surface of the sidewall part 2 that restricts the concrete product 1 towards the concrete product, in which case the movement of the removal device forces the sidewall unit to be detached and removed from the surface of the concrete product 1.

When the removable sidewall units of the mold are detached from the casting bed and from the cast concrete product, said sidewall units, complete with their fastening magnets, as well as the cast product, are all removed from the casting bed, and the casting bed with the mold is prepared for a new casting process.

FIG. 2 is a schematical illustration of the structure and principle of operation of a removal unit 7 according to the invention. The removal unit 7 illustrated in the figure comprises a frame structure 8, a removal device 9 and a removal device operating tool 10.

In the embodiment of FIG. 2, the removal device 9, extending from the front surface of the frame structure 8 of the removal device 7 to outside the frame structure, is moved in the axial direction of the removal device, by rotating the removal device operating tool 10 on the central axis of said tool. Now the gear wheel 11 that is fixedly fastened to the removal device operating tool 10 or formed therein, said gear wheel being connected to the gearing 12 formed in the removal device 9, forces the removal device in an axial motion.

The removal unit 7 is advantageously attached, by its frame structure 8, to the sidewall unit support structure and/or to the sidewall part, and a suitable aperture is provided in the sidewall part for the removal device 9 of the removal unit 7. In addition, necessary apertures or spaces are provided in the support structure for the removal device operating tool 10 of the removal unit 7, and for using the tool.

A removal unit 7, representing the type according to the invention illustrated in FIG. 2, is advantageously suited to be used with a sidewall robot, in which case the sidewall robot can use the removal device 6 by suitable equipment and by intermediation of the removal device operating tool 10. Thus the sidewall units stuck in the cast product can be detached with the robot without separate manual removal work, and thereby the whole casting mold can be dismounted by the sidewall robot alone, which makes the casting process more rapid and more efficient.

FIG. 3 is a schematical illustration of the structure and principle of operation of an alternative embodiment of the removal unit 13 according to the invention. The removal unit 13 illustrated in the figure comprises a frame structure 14, a removal device 15 and a removal device operating tool 16.

In the embodiment of FIG. 3, the removal device 15 extending from the front surface of the frame structure 14 of the removal unit 13 to outside the frame structure, advantageously for the magnitude of the thickness of the sidewall part, is moved in the lengthwise direction of the removal device, i.e. on the horizontal level, by pressing the removal device operating tool 16 down. Now the wedged surface of the removal device operating tool 16, which is substantially in contact with the rear end of the removal device 15, forces the front end of the removal device to move outwards from the frame structure 14. By this horizontal movement, the front end of the removal device 15 forces the sidewall part, and hence the whole sidewall unit, via the removal unit frame structure and the sidewall unit frame structure, to be removed from the cast concrete product.

When the sidewall unit is detached from the cast concrete product, and the force pushing the removal device operating tool 16 down ceases to affect the removal device operating tool, the tool 16 is returned to its starting position due to the effect of a spring element 17. Simultaneously the removal device 15 is also returned to its starting position due to the effect of a spring element 18. In order to define the correct starting position for the removal device 15, the frame structure 14 of the removal device can be provided with a stop face or element 19, against which the protrusion or bracket 20 provided in the removal device is pressed due to the effect of the spring element 18.

The removal unit according to the embodiment illustrated in FIG. 3 can be used by a simple vertical motion or pressure, in which case it is easily usable by intermediation of a sidewall robot, without any separate equipment.

1. A sidewall unit for a casting mold, said sidewall unit comprising a sidewall part restricting the outer surface of a concrete product to be cast, and a support structure for said sidewall part, wherein the sidewall unit includes at least one removal device extending through the sidewall part, said removal device being at least partly movable outwardly from the surface level of the sidewall part, in order to detach the sidewall unit from the hardened concrete product.

2. A sidewall unit according to claim 1, wherein the removal device forms part of a separate removal unit to be attached to the sidewall unit.

3. A sidewall unit according to claim 1, wherein the removal device is a substantially rod-like element, the location of which in relation to the sidewall unit can be adjusted by a removal device operating tool.

4. A sidewall unit according to claim 1, wherein the removal device is placed substantially in the area of the end of the sidewall unit.

5. A sidewall unit according to claim 1, wherein the sidewall unit is provided with means for fastening the sidewall unit to the casting bed by at least one separate magnet unit.

6. A sidewall unit removal unit for removing a sidewall unit from a hardened concrete product, said removal unit being detachably fastened to the sidewall unit, wherein the removal unit comprises a frame and at least one removal device adapted to be fitted to extend through a sidewall part of the sidewall unit, said removal device being at least partly movable in a direction away from the removal unit frame.

7. A removal unit according to claim 6, wherein the removal device is a substantially rod-like element, the location of which in relation to the removal unit frame can be adjusted by a removal device operating tool.

8. A removal unit according to claim 7, wherein the removal device is moved by rotating the removal device operating tool.

9. A removal unit according to claim 7, wherein the removal device is moved by pressing down the removal device operating tool.

10. A sidewall unit according to claim 2, wherein the removal device is a substantially rod-like element, the location of which in relation to the sidewall unit can be adjusted by a removal device operating tool.

11. A sidewall unit according to claim 2, wherein the removal device is placed substantially in the area of the end of the sidewall unit.

12. A sidewall unit according to claim 3, wherein the removal device is placed substantially in the area of the end of the sidewall unit.

13. A sidewall unit according to claim 2, wherein the sidewall unit is provided with means for fastening the sidewall unit to the casting bed by at least one separate magnet unit.

14. A sidewall unit according to claim 3, wherein the sidewall unit is provided with means for fastening the sidewall unit to the casting bed by at least one separate magnet unit.

15. A sidewall unit according to claim 4, wherein the sidewall unit is provided with means for fastening the sidewall unit to the casting bed by at least one separate magnet unit.
